(19) United States
(12) Patent Application Publication
(10) Pub. No.: US 2022/0287494 A1
(43) Pub. Date: Sep. 15, 2022

(54) BEVERAGE POD

(71) Applicant: Nexe Innovations Inc., Surrey (CA)

(72) Inventors: Darren Joseph Footz, Surrey (CA); Seth Cronin, Williston, VT (US); Paul Bhogal, Surrey (CA)

(21) Appl. No.: 17/694,285

(22) Filed: Mar. 14, 2022

Related U.S. Application Data
(60) Provisional application No. 63/160,586, filed on Mar. 12, 2021.
(60) Provisional application No. 63/160,590, filed on Mar. 12, 2021.
(60) Provisional application No. 63/160,595, filed on Mar. 12, 2021.
(60) Provisional application No. 63/160,597, filed on Mar. 12, 2021.

(51) Int. Cl. A47J 31/36; A47J 31/06

(52) U.S. Cl. CPC A47J 31/368; A47J 31/0615

(57) ABSTRACT

A beverage pod is provided. The beverage pod includes an outer shell having a bottom layer and a lid opposite the bottom layer. The lid is operable to be breached by a fluid injecting component of a beverage brewing machine so that a liquid can be injected into the beverage pod. The liquid mixes with a beverage material contained in a filter to form a beverage. The bottom layer is operable to be breached by a brewing pin from a beverage brewing machine. Upon breach of the bottom layer by the brewing pin, the beverage flows out of an outlet created by the brewing pin.

### CROSS-REFERENCE TO RELATED APPLICATION(S)

This application claims priority benefit to U.S. Provisional Patent Application No. 63/160,586, filed in the U.S. Patent and Trademark Office on Mar. 12, 2021, U.S. Provisional Patent Application No. 63/160,590, filed in the U.S. Patent and Trademark Office on Mar. 12, 2021, U.S. Provisional Patent Application No. 63/160,595, filed in the U.S. Patent and Trademark Office on Mar. 12, 2021, and U.S. Provisional Patent Application No. 63/160,597, filed in the U.S. Patent and Trademark Office on Mar. 12, 2021, each of which is incorporated herein by reference in its entirety for all purposes.

### FIELD

The present disclosure relates to a beverage pod such as, for example, a compostable beverage pod for single-serve use. The present disclosure further relates to the beverage cartridges or pods for use in single serving beverage brewing machines, for example beverage pods that are biodegradable.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Single-serve beverage pods have become a dominant method for serving beverages, especially hot beverages, in a variety of settings such as homes, offices, waiting rooms, hotel rooms and lobbies, and other places where people consume beverages. The rapid growth of single-serve beverage pods is driven by consumer preference for convenient, quickly prepared beverages in single-portion quantities, in a variety of flavors, beverage types (coffee, espresso, decaffeinated coffee, tea, decaffeinated tea, cider, hot cocoa/chocolate, bone broth, and even alcoholic beverages, such as, for example, Irish Coffee, Hot Toddy, Hot Buttered Rum, etc.). Even within a beverage type, such as coffee, there may be a plurality of roasts and associated roasters, flavor profiles, flavor additives, caffeine strengths, location or locations of origin, etc.

The convenience and variety of single serving beverage pods allows and encourages consumers to prepare and consume a plurality of beverages throughout the day. This pattern of consumption causes the rapid accumulation of used beverage pods wherever they are consumed. Due to the nature of single-serving beverage pods, a considerable amount of packaging waste is produced per beverage consumed compared to preparing beverages by traditional means, such as, for example, preparing a plurality of servings at once using bulk ingredients. Packaging waste, according to the United States Environmental Protection Agency (EPA), defines outer shells and packaging as products that are assumed to be discarded the same year the products they contain are purchased. The EPA further estimates that the majority of the solid waste are packaging products. Packaging waste contributes significantly to global pollution, the introduction of contaminants into the natural environment that cause adverse change, which poses a health risk many forms of life, including humans, other animals, plants, fungi, etc.

### BRIEF DESCRIPTIONS OF THE DRAWINGS

FIG. 1A illustrates an example beverage brewing system.

FIG. 1B illustrates an example of a conventional beverage pod.

FIG. 1C illustrates a schematic view of a portion of a beverage brewing machine.

FIG. 2A illustrates a hollow registration element beverage pod.

FIG. 2B illustrates a low-density registration element beverage pod.

FIG. 2C illustrates a loose registration element beverage pod.

FIG. 3A illustrates a beverage pod having a layered filter.

FIGS. 3B and 3C illustrate a beverage pod with a deformable filter.

FIGS. 4A-4C illustrate a beverage pod with a multistate registration element.

FIGS. 5A-5B illustrate a beverage pod with a multistate filter.

FIG. 6A illustrates beverage pod with one or more porous sides.

FIG. 6B illustrates a beverage pod with a shearing region.

FIGS. 7A and 7B illustrate beverage pods having puncture resistant components.

FIGS. 8A-8D illustrate beverage pods having pin alignment portions.

FIG. 9 illustrates a method of utilizing the beverage pod.

FIG. 10 illustrates a method of manufacturing the beverage pod.

### DETAILED DESCRIPTION

Disclosed herein is a single-serving beverage pod that increases and/or maximizes the amount of beverage material. The beverage pod includes additional volume compared to a conventional beverage pod. The beverage pod includes a shelf that can support the shape of the filter. The shelf forms a receiving portion operable to receive a brewing pin from a brewing beverage machine. The receiving portion can have substantially a toroidal shape, as the chamber (or additional chamber(s)) extend towards the bottom layer of the beverage pod while avoiding the brewing pin. Accordingly, the volume of beverage material(s) can be increased and/or optimized to provide a better beverage.

Single-serve beverage pods can include several components made of various materials. For example, the components of a single-serve beverage pod can include, at least, an outer shell, for example made from plastic such as polyethylene, a filter, for example made from plant fiber such as abaca fibers or other natural and synthetic fibers, and a outer shell lid, for example made from food-grade aluminum foil, which is also commonly printed upon to include product labelling. Some beverage pods do not contain a filter because the beverage material is readily soluble in hot water (such as, for example, hot cocoa). The outer shell can include an opening on the top of the outer shell, and a hollow cavity within which and across which a filter may be disposed. The outer shell may also include an opening at on the bottom outer shell. After the filter and beverage material are inserted into the outer shell, the lid is then typically sealed over the outer shell opening or openings. The sealed lid typically provides an airtight seal, preventing the exchange of gases between the environment and the interior of the outer shell, thus preventing oxidation and/or spoilage of the beverage material. In beverage pods that comprise a filter, the filter may separate the outer shell into two chambers: a first chamber occupying the space within the outer shell between the filter and the opening of the outer shell, the first chamber for holding dry beverage ingredients such as, but not limited to, coffee, tea, or cocoa, for a single beverage serving; and a receiving portion occupying the space within the outer shell between the filter and the bottom of the outer shell, the receiving portion being on the opposite side of the filter to the first chamber.

The purpose of the receiving portion is typically to provide a space in which a fluid extractor of a beverage brewing device may be inserted into the bottom of the outer shell, entering the receiving portion and allowing the extraction of fluid from the pod without the fluid extractor entering the first chamber, such that fluid must flow through the beverage material and the filter before exiting the pod via the fluid extractor. However, the presence of the second chamber may significantly reduce the space within the outer shell that can be occupied by beverage medium. This may be problematic as the total amount of beverage material disposed within the outer shell may significantly contribute to the final concentration of the beverage, typically measured in Total Dissolved Solids (TDS). It may be advantageous to minimize the volume of the second chamber in order to maximize the volume on the third chamber, thereby maximizing the total volume available for beverage material. However, the fluid extractor is typically comprised of a sharp, hollow needle-like piercing element designed to easily pierce through the bottom of the outer shell, such that if the second chamber is reduced in size, the fluid extractor may penetrate or damage the filter, allowing the beverage material to exit the first chamber, and ultimately exit the pod via the fluid extractor. Thus, in the event the fluid extractor penetrates or damages the filter, the beverage material may be transported into the final beverage, which may be undesirable to consumers (such as, for example, the presences of coffee grounds in a prepared cup of coffee) and may potentially damage the beverage brewing machine (for example, by way of clogging the fluid extractor with beverage material).

The lid is disposed over the opening of the outer shell (which may be, for example, over the top of the outer shell, and/or bottom of the outer shell), and keeps the dry beverage ingredients within the outer shell, as well as providing an airtight seal to prevent the oxidation and other types of degradation of the outer shell's contents. In practice, a single-serving beverage pod is placed into a compartment of a brewing machine. The machine is activated such that a fluid injector penetrates the cover of the pod and a fluid extractor penetrates the base of the pod (which may also be a cover). The fluid injector injects a brewing medium (e.g. hot water) into the first chamber for extracting beverage components from the ingredients. The brewing medium containing the extracted beverage components percolates through the filter and into the second chamber. The brewing medium containing the extracted or dissolved beverage is then extracted by the fluid extractor and finally dispensed as a drinkable beverage.

Conventionally, the outer shell of a beverage pod for single-serve use is typically made from petroleum-based plastic materials which are neither biodegradable nor compostable. In some cases, the outer shell may be made of petroleum biodegradable materials, such as Polybutylene adipate terephthalate (PBAT). While these materials may eventually biodegrade, they are not desirable for use in home or industrial composting settings, as they may pollute the compost with petroleum residue, microplastics, and other chemicals that may not be desirable for compost. Composting is the mixing of various decaying organic substances, such as dead plant matter, which are allowed to decompose to the point that various waste products of the composting process provide nutrients to be used as soil conditioners/fertilizers. Composting can be aerobic, anerobic, and/or vermicomposting, depending on the environment in which the compost is prepared. Aerobic composting is the decomposition of organic matter by microbes that require oxygen to process the organic matter. The oxygen from the air diffuses into the moisture that permeates the organic matter, allowing it to be taken up by the microbes. Anerobic composting is the decomposition of organic matter by microbes that do not require oxygen to process the organic matter. To be anerobic, the system must be sealed from the air, such as with a plastic barrier. Anerobic compositing produces an acidic environment to digest the organic material. Vermicomposting is the decomposition of organic matter by worms and other animals (such as soldier flies). A portion of the organic matter is converted to vermicast, or castings from the worms or other animals. The breakdown of the organic matter into vermicast yields an effective soil conditioner and/or fertilizer.

The lid of a beverage pod can be made of a polypropylene and a metal foil (e.g., aluminum) or a metal foil laminate which is affixed to the top of the outer shell with thermal welding or some other means (e.g. adhesives). Generally, neither the metal foil of the cover nor the glue affixing the cover over the opening of the outer shell is biodegradable, compostable, or made from readily renewable resources. As a result, non-biodegradable and non-compostable beverage pods typically end up in landfills, thereby at least contributing to environmental concerns associated with disposal of trash. This may be especially problematic due to the fact that traditional means of brewing beverages, e.g., using solely beverage material and filter material, or a filtration device (such as a French press, or a wire mesh filter) may yield a completely compostable waste product (e.g., spent coffee grounds and potentially a used paper filter).

Attempts have been made to recycle plastic beverage pods in some cases. Recycling has many issues which effect the efficacy and practicality of these programs. The first is collection and transportation. Collection largely requires voluntary compliance by consumers. Some deposit programs encourage consumers to return recyclable materials, however this accounts for very few recyclable materials. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in the end product and can include materials such as other non-recyclable waste, or other recyclable wastes not compatible with the desired recycled material which can include other plastics. This requires sorting and cleaning of materials. This process may be partially automated; however, it also requires manual sorting and inspection which adds cost, reduces the amount of material that can be processed and inevitably results in a less pure product than when using virgin material. This frequently results in downcycling.

Downcycling is the term used to describe the reduction of quality in recycled materials compared to materials prior to being recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage outer shells, such as instant beverage cups or pods, can be particularly difficult to recycle. Not only do they have non-recyclable material contained within them that would first need to be removed, they are frequently comprised of at least two different materials, such as a plastic cup and an aluminum foil lid. When the lid is made of plastic, it is often a different type than the cup, and would require separation prior to processing when being recycled. This increases the complexity of the recycling operation, requiring at least three separate streams for each type of refuse, each requiring their own preparation. Furthermore, the small size of these beverage pods creates a disproportionate amount of effort required to recycle a small amount of material. The separation of materials would ideally be performed by the consumer prior to recycling; however, this inconvenience will inevitably result in consumers recycling the beverage outer shells without proper preparations, or failing to recycle the outer shell at all, electing to discard the outer shell as trash. One of the major advantages of using beverage pods is consumer convenience, such that a beverage can be prepare by simply inserting a pod into a machine that performs all other brewing functions. It is therefore undesirable to instruct consumers to disassemble and sort various materials from the beverage pod, and due to the diminutive size of beverage pods, this may not be physically possible for consumers without fine motor skills necessary to disassemble such an item. The result is a required step of preprocessing the outer shells before they can be recycled to ensure the materials are separated and the recyclable material sufficiently cleaned.

Plastics are traditionally sourced from petroleum. They are processed with chemicals to create polymers which can then be formed into shapes. Such polymers that are heated to be formed and then hold their shape when cooled are called thermoplastics. Many of the chemicals used to produce these polymers are inherently toxic and can leech into the contents. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals, such as BPA (Bisphenol A). Other chemicals that can be found in plastics include thalates, antiminitroxide, brominated flame retardants and poly-fluorinated chemicals. Depending on the chemical and the manner in which the plastic is being used, it can cause problems including irritation in the eye, vision failure, breathing difficulties, respiratory problems, liver dysfunction, cancers, skin diseases, lung problems, headache, dizziness, birth defects, as well as reproductive, cardiovascular, genotoxic and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based or bioplastics, which originate from biomass, are biodegradable. Only a small subset of these is also compostable. The distinction lies in how quickly the plastic breaks down, and whether the process of degradation releases harmful chemicals into the environment. Compostable plastics typically degrade within 12 weeks, wherein biodegradable plastics will typically break down within 6 months. Ideally, compostable plastics would break down at the same rate as common food scraps, about 90 days.

Another class of plastics are OXO-degradable plastics. These are different than biodegradable plastics in that they are traditional plastics with additional chemicals which accelerate the oxidation and fragmentation of the materials under UV light and/or heat. This allows the plastics to break down more quickly, however the result is pollution from microplastics, as the plastic molecules themselves do not degrade any faster than their traditional plastic counterparts. There have been efforts in some jurisdictions to ban these plastics.

Beverage pods used in single serve brewing machines which contain insoluble beverage material such as coffee grounds or tea leaves typically contain some form of filter to prevent the insoluble beverage material from exiting the beverage pod. These filters can be susceptible to puncture or tearing by the brewing pin which penetrates the bottom of the beverage pod which may render the filters ineffective. A reliable method of preventing penetration of the filter is needed.

Filters or filter mediums can be effective at preventing insoluble beverage material from exiting a beverage pod via the brewing pin of a beverage brewing machine, however the filter or filter medium can also occlude the outlet preventing the liquid from exiting the beverage pod. As such, a method for preventing the occlusion of the outlet is necessary.

Beverage pods have a predefined size and shape due to their need to be compatible with a specific beverage brewing machine. This creates a limit to the size of the beverage pod and therefore the amount of beverage material that can be included. Features like a registration element may be used to protect a filter from damage, however these components take up space within the beverage pod which could otherwise be used to contain beverage material. By creating a filter which resists tearing and occlusion, a registration element is no longer necessary providing the opportunity to increase the amount of beverage material in the beverage pods.

Methods to improve the damage resistance of a beverage pod filter without consuming a substantial volume of the beverage pod typically involve methods which are difficult or costly to manufacture. A simpler and more easily manufactured pod filter is desired.

Removing the need for a registration element to protect a filter from a brewing pin allows for more beverage material to be inserted into a beverage pod. This allows users to brew a larger amount of beverage with one beverage pod. The user experience is improved by the ability to brew a stronger beverage or a larger volume of beverage at currently available concentrations while additionally preventing insoluble beverage material from escaping the beverage pod or the outlet of the brewing chamber from becoming clogged by the filter or beverage material. It is therefore desirable to protect the beverage filter from being damaged by the piercing element in a beverage brewing machine, while maximizing the TDS in the beverage pod and simplifying the assembly process. There exists a need to provide a beverage pod which is capable of avoiding the piercing element while maximizing the available space for beverage material.

Beverage pods are typically designed to be symmetrical and typically have a constant thickness bottom of the beverage pod. The case is usually the same for the pod lid, so that the rotational orientation of the beverage pod does not impact how it interacts with a beverage brewing machine. This can make penetrating the beverage pod difficult, and while thinner material could be used, it would create large surfaces which could be vulnerable to damage rendering the beverage pod useless.

Because of the need of symmetry for beverage pods to function in most beverage pods, the design options are somewhat limited. For example, a small void intended to contain the beverage pod cannot be created to isolate the brewing pin to prevent it from damaging the filter unless the brewing pin is positioned to contact the center of the beverage pod. This often results in the need for such isolating void space to be continuous around the bottom of the beverage pod which consumes space which could otherwise be used to store beverage material or to brew the beverage.

Aligning the beverage pod in a desired orientation ensures that the beverage pod consistently performs in a predictable manner. It additionally creates flexibility in the design of the beverage pod allowing more beverage material to be loaded into the beverage pod and more space for brewing to occur.

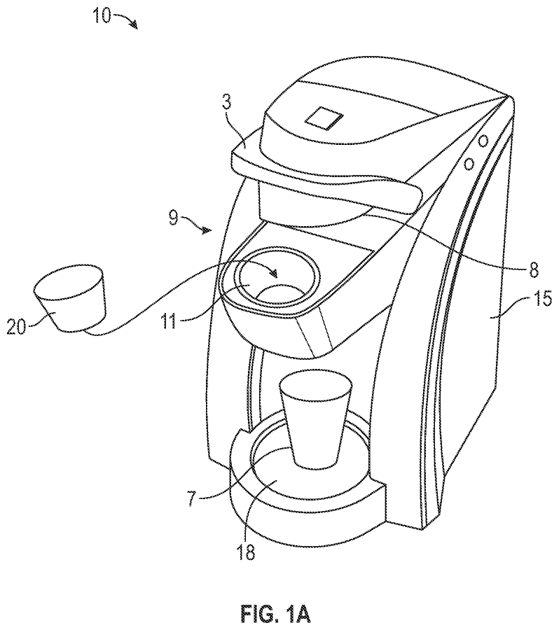

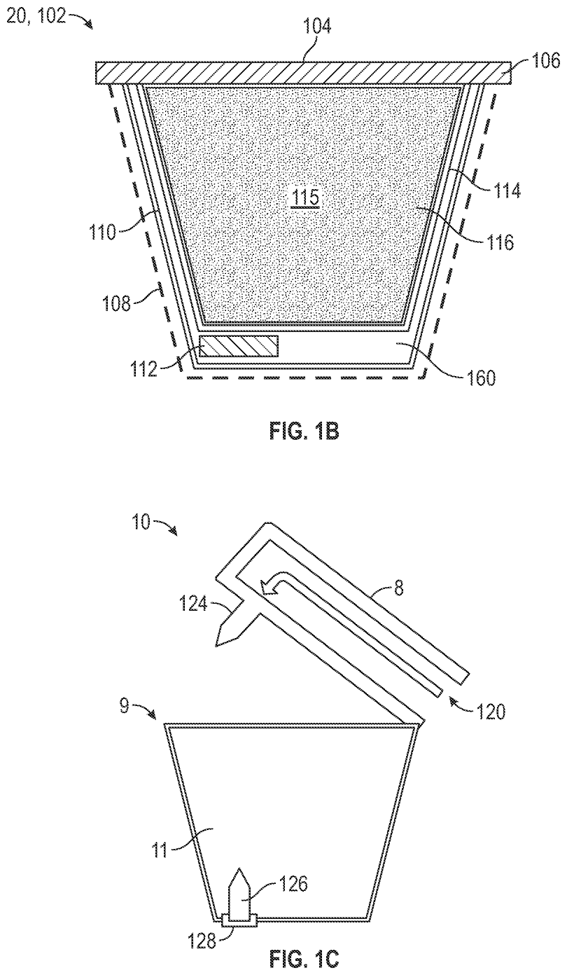

FIG. 1A illustrates a beverage brewing system 10 operable to brew a beverage. The beverage brewing system 10 includes a beverage brewing machine 3 and a beverage pod 20. The beverage brewing machine 3 is operable to receive the beverage pod 20 and may be used to form any suitable beverage, such as tea, coffee, or other infusion-type beverages. Beverages may be formed from a liquid and/or dry materials, for example to make soups, juices or other beverages made from dried materials, other materials. The beverage brewing machine 3 can create a beverage that is deposited into a user's cup 7. In at least one example, the user can position the cup 7 onto a platform 18. In some examples, the user may position the cup 7 on a tabletop. The beverage pod 20 can be inserted into a pod holder 9 which has a brewing chamber 11 operable to receive the beverage pod 20. In at least one example, the beverage pod 20 may be manually or automatically placed in the pod holder 9. A cover 8 can at least partially cover the brewing chamber 11 to at least partially enclose the beverage pod 20 in the pod holder 9 in which the beverage pod 20 is used to make a beverage.

FIG. 1B illustrates a beverage pod 20, for example an example of a conventional beverage pod 102. Beverage pods 102, or beverage cartridges, are outer shells, pods, capsules, etc., for use in the beverage brewing machine 3, such as a coffee maker. The beverage pod 20 may include one or more of, a beverage medium 116 that is either soluble or insoluble, one or more filters 114, and a first portion 115 in which liquid is passed into and a second portion 112 through which liquid passes out of the beverage pod 20. In some examples, the beverage pods 20 can be portioned beverage packages that can contain a water-soluble material, to make a drink such a hot chocolate, chai tea, etc. These portioned packages can be pouches as well as pods for beverage brewing machines 3.

The beverage pod 102 can contain a number of components, including lid 104. The lid 104 is operable to close the beverage pod 102 to contain the beverage medium 116 in the first portion 115. The lid 104 can be made of, for example, a foil that is sealed to the beverage pod 20 so as to contain the beverage material 116. A compostable lid 104 may be comprised of, for example a spun bond PLA web film (which may contain, for example, a proportion of PHA), a cellulose paper film, etc. The pod bond 106 is the connection between any two of the lid 104, outer shell 108, and/or pod interior 110. The pod bond 106 can be mechanical or chemical, and such as adhesives, heat sealing, ultrasonic welding, etc. The pod bond 106 can be in one place or separately depending upon the use case. The pod bond 106 can include a filter bond that binds the filter medium to a portion of the beverage pod 20, such as by ultrasonic welding, adhesives, thermal sealing, etc.

A pod exterior 108 is the outer shell of the beverage pod 20. The exterior 108 can be made of plastic (especially compostable plastic, such as PLA, PHA, or combinations thereof), cellulose, etc. The pod exterior 108 can have similar properties to other thermoplastic polymers such as polypropylene (PP), polyethylene (PE), or polystyrene (PS). This allows it to serve as a biodegradable alternative for coffee pods. In some examples, the pod exterior 108 can also be made from polyhydroxyalkanoates (PHAs), which are a biodegradable polyester produced through bacterial fermentation of sugar or lipids. The pod exterior 108 can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage pod 20. PLLA is also readily renewable, typically made from fermented plant starch such as from corn, cassava, sugarcane, or sugar beet pulp. Cellulose fibers are fibrous materials made from plant materials such cotton, flax, wood pulp, etc. Cellulose fibers can provide a biodegradable filter material that could be used in coffee pods. Other materials that are biodegradable plastic alternatives include petroleum-based plastics such as, Polyglycolic acid (PGA), Polybutylene succinate (PBS), Polycaprolactone (PCL), Polyvinyl alcohol (PVOH), and/or Polybutylene adipate terephthalate (PBAT).

In some examples, beverage pods 20 can also contain a pod interior 110 that is separate from a filter 114, in beverages that have an insoluble beverage material such as coffee. The pod interior 110 can be used for a number of purposes, including, providing material properties such as structural integrity (e.g., provide addition strength to resist the pressure of liquid injection in the process of brewing a beverage, which may crack or otherwise compromise the beverage pod 20), and/or altering the biodegradability or rate of the beverage pod 20. A registration element 112, or registration element, is a solid structure integrated into a beverage pod 20 that prevents the brewing pin 126 (shown in FIG. 1C) from creating a path for the insoluble beverage material from inside the filter 114 to the outlet. In some examples, the pod interior 114 may include integrated features to act as a registration element 112, removing the requirement for a discrete component.

The filter 114 can be a medium, such as spun bond PLA web, paper (cellulose), cloth or metal, that is used to prevent an insoluble beverage material 116 from leaving the beverage pod 20 and entering the beverage brewing machine 3 or the beverage. Filters 114 can be symmetrical (e.g., fluted), or asymmetrical (e.g. pleated).

Beverage material 116 is the material used to produce a brewed beverage, such as coffee grounds, tea, or a mix beverage where the beverage material is soluble, such as hot chocolate. Beverage material 116 may include any flavorings, nutritional content (e.g., any oils, nutritional supplements, active ingredients such as pharmaceuticals, cannabinoids, etc.), alcohol, coloring, or any other composition which has an effect on the final beverage.

Referring to FIGS. 1A, 1B, and 1C, beverage brewing machines 3 for brewing portioned beverages from pre-packed beverage pods 20 exist for a variety of beverages made from a beverage material 116 that is either insoluble, such as coffee, or soluble, such as hot chocolate. A beverage brewing machine 3 can contain many other components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, the beverage brewing machine 3 contains all components necessary to accomplish the beverage brewing process, though specific reference to beverage brewing machine components may only be made to those components which come into direct contact with the beverage pod 20, such as the brewing chamber 11, a fluid injecting component 124, and a brewing pin 126. The beverage brewing machine 3 can contain a fluid source 120 that supplies the liquid, which may be water, to the brewing machine 3 for producing the desired beverage. A cover 8 can be opened to allow a new beverage pod 20 to be added to the beverage brewing machine 3. The beverage pod 20 can be received in the brewing chamber 11. In some examples, the cover 8 contacts the fluid source 120 to the fluid injecting component 124, but the fluid source 120 does not have to be provided in the cover 8. A fluid injecting component 124 can be operable to breach the lid 104 and be in fluid communication with the first portion 115. In some examples, the fluid injecting component 124 can include a piercing component to pierce the lid 104. The fluid injecting component 124 can provide a liquid, typically hot water, to mix with the beverage medium 116 to create the beverage. A brewing pin 126 can be operable to breach the bottom of the beverage pod 20 to allow the brewed beverage to leave the beverage pod 20 and/or the brewing chamber 11. In some examples, the brewing pin 126 can be operable to breach the beverage pod 20 through the second portion 112. The second portion 112 may be located opposite the first portion 115 in relation to the filter 114 such that the beverage can be extracted without the beverage material 116. In some examples, the brewing pin 126 may pierce or deform other components of the beverage pod 20 to breach the beverage pod 20.

As shown in FIG. 1B, the conventional beverage pod 102 has a large receiving portion 160 disposed underneath the filter 114. The receiving portion 160 is disposed between the filter 114 and the bottom of the beverage pod 102. Conventionally, the filter 114 has a substantially flat bottom which is substantially parallel with the bottom of the beverage pod 102. Conventional beverage pods 102 leave such a large receiving portion 160 in order to prevent the brewing pin 126 from penetrating the filter 114. The brewing pin 126 can be fluidly coupled to an outlet through which the beverage can be deposited into the cup 7.

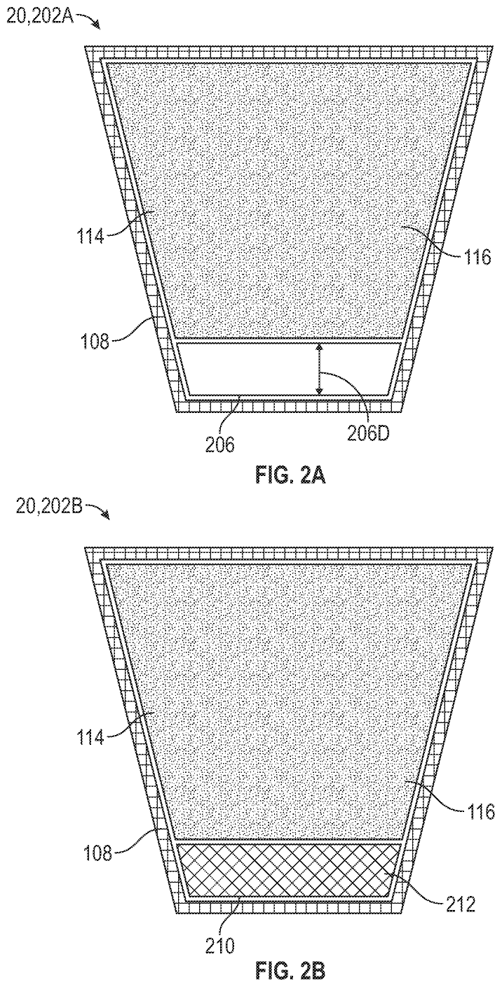

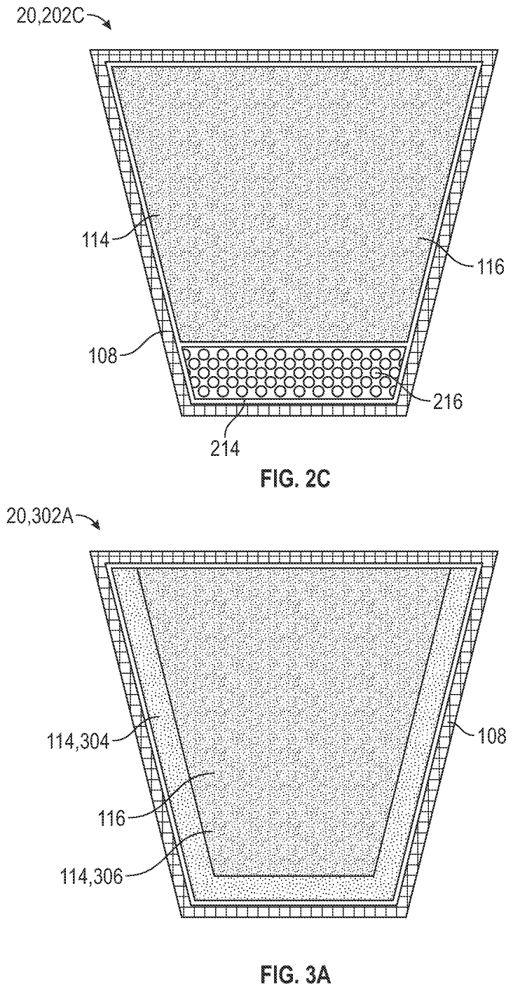

FIGS. 2A-2C illustrate beverage pods 20 with registration elements 206, 210, 214 which are operable to protect the filter 114 from damage due to penetration of the brewing pin 126 while still permitting fluid to flow through and/or across the registration elements 206, 210, 214 to the outlet 128.

FIG. 2A illustrates a beverage pod 202A with a hollow registration element 412. The hollow registration element 412 is substantially comprised of void space. The hollow registration element 412 may be a physical structure containing a discrete void space or may alternatively be a space between the bottom of the beverage pod 202 and the filter 114. The void space in the hollow registration element beverage pod 202A prevents the brewing pin 126 from penetrating and damaging the filter 114 to ensure the insoluble beverage material 116 remains within the beverage pod 202. The hollow registration element 412 may be a discrete component or may be a feature of a beverage pod 102 or another component of a beverage pod such as the bottom of the pod exterior 108 or a filter 114. The hollow registration element 412 can include a feature of the bottom of the pod exterior 108 of the hollow registration element beverage pod 202 which creates a hollow space between the bottom of the pod exterior 108 and the filter 114 a predetermined distance 206D. For example, the predetermined distance 206D may be at least 5 mm to prevent the beverage pin from contacting and potentially damaging the filter 114. The hollow registration element 412 may contain some additional structure to prevent collapse and will allow for fluid to flow through or around the hollow registration element when contacted by the brewing pin 126.

In at least one example, the hollow registration element 412 may contain a liquid, such as a flavoring or sweetener intended to be released and flow through the outlet 128 when penetrated by the brewing pin 126. In at least one example, the top of the hollow registration element 412 can form holes or other features to allow fluid to flow into it from above, and out the bottom of the hollow registration element beverage pod 202A when penetrated by a brewing pin 126.

In at least one example, the hollow space of the hollow registration element 412 can prevent occlusion of the outlet 128. In some examples, the hollow registration element 412 can include a sealed hollow disk placed within the bottom of the beverage pod 202A filled with a fluid such as a creamer. The bottom of the sealed disk can be penetrated by the brewing pin 126 during use. The top of the sealed disk may additionally be penetrated by the brewing pin 126 during use and/or may otherwise be displaced to allow fluid to flow through the hollow registration element 412 and subsequently through the outlet 128. In some examples, the sealed disk may be raised from the surface or otherwise positioned to allow liquid from inside the hollow registration element beverage pod 202A to flow around the hollow registration element 412 to allow the liquid to exit the hollow registration element beverage pod 202 without needing to penetrate the top of the sealed disk.

FIG. 2B illustrates a low-density registration element beverage pod 202B. A low-density registration element beverage pod 202B is a beverage pod 102 with a registration element 210 containing an internal structure which is neither hollow nor solid. For example, the internal structure may comprise a series of discrete hollow chambers 212 or may contain an open lattice of support structures 212. The low-density registration element beverage pod 202B may contain a flexible or plastically deformable internal structure 212 which is operable to deform around a brewing pin 126 when the brewing pin 126 penetrates the low-density registration element beverage pod 202B. In at least one example, the low-density registration element beverage pod 202B contains a honeycombed registration element 210 containing a repeating hollow lattice 212 of PLA. A honeycombed registration element 210 may be used to describe any low-density registration element 210 in a low-density registration element beverage pod 202B. The honeycombed registration element 210 may include a network of hollow chambers 212 or may alternatively be formed by a hollow network of repeating supporting structures 212. The honeycombed registration element 210 may be made of rigid materials such as PLA or may alternatively be comprised of flexible materials such as polymers of isoprene or a composite compound including a mixture of polymers of isoprene and poly(3-hydroxybutyrate-co-3-hydroxyvalerate) (PHBV). In at least one example, a honeycombed registration element 210 can include a repeating pattern of, hollow hexagonal prisms such that the vertices are solid with a thickness of no more than 1 mm and the faces can be hollow.

FIG. 2C illustrates a loose registration element beverage pod 202C. A loose registration element beverage pod 202C is a beverage pod 102 with a registration element 412 containing a large diameter filter medium 216. Alternatively, the registration element 412 may be replaced by a large diameter filter medium 216. The registration element 412 and/or the large diameter filter medium 216 can be provided to reduce and/or prevent damage to the filter 114 by the brewing pin 126 while allowing the beverage to flow out the outlet 128. When contacted by a brewing pin 126, the large diameter filter medium 216 is displaced while allowing liquid to flow freely around the large diameter filter medium 216 and out the loose registration element beverage pod 202C via the outlet 128. The loose registration element beverage pod 202C may use a large diameter filter medium 216 in addition to a traditional filter 114 which may be comprised of a spun PLA web or cellulose paper or cloth. In at least one example, the large diameter filter medium 216 can be comprised of PLA spheres between 2 millimeters and 3 millimeters in diameter that can be used together with a spun PLA filter 114. A large diameter filter medium 216 can include a loose filter medium comprised of particles which may be too large to prevent the outflow of beverage material 116 from a beverage pod 20, however are large enough such that they are easily displaced to allow liquid to flow through the medium 216 and out an outlet 128 without becoming clogged. The large diameter filter medium 216 may range from 1 millimeter to 5 millimeters in diameter and may be smooth or porous. The large diameter filter medium 216 may be made of any material including plastic, ceramic etc. In at least one example, the large diameter filter medium 216 can include spheres of PLA measuring between 2 millimeters and 3 millimeters in diameter. In some examples, the large diameter filter medium 216 are spheres of ceramic material 3 millimeters to 4 millimeters in diameter.

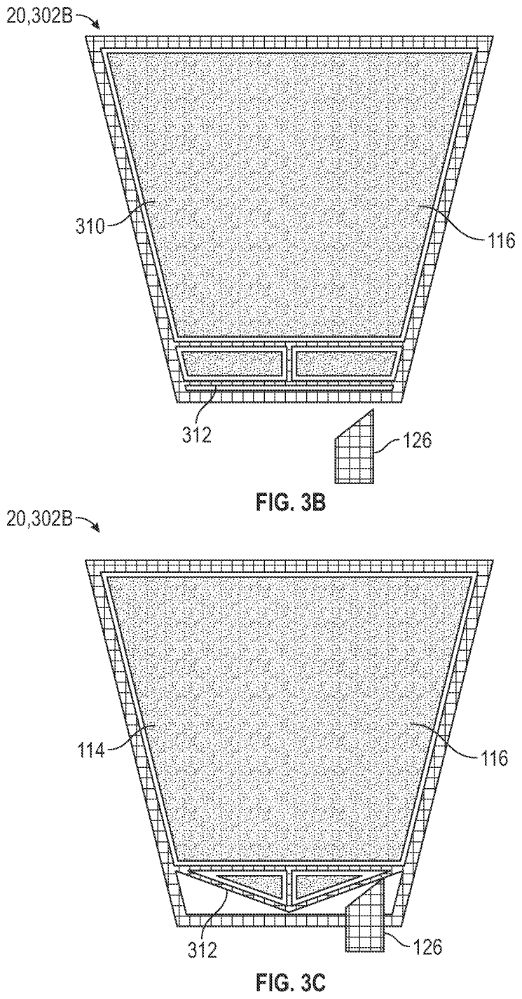

FIGS. 3A-3C illustrates configurations of beverage pods 20 with configurations of filter(s) 114 which are operable to resist damage from contacting the brewing pin 126 while still permitting fluid to flow through and/or across the filters 114 to the outlet 128.

FIG. 3A illustrates a beverage pod 502A having a layered filter 114. A layered filter beverage pod 502A is a beverage pod with multiple layers 304, 306 of filter 114. In at least one example, the layered filter beverage pod 502 can include a fine filter 306 for containing beverage material 116, and a coarse filter 514 disposed between the fine filter 306 and the external walls 108 of the beverage pod 20. Accordingly, the coarse filter 514 can be disposed about the fine filter 306 opposite the beverage material 116. The coarse filter 514 can be operable to protect the fine filter 306 from damage from the brewing pin 126 while preventing the brewing pin 126 from being occluded by the fine filter 306 or the coarse filter 514. The coarse filter 514 may be a reinforcing layer. The coarse filter 514 can be a reinforcing layer attached to and/or layered around a fine filter 306 for providing protection to the fine filter 306 while preventing occlusion of the brewing pin 126. The coarse filter 514 may be comprised of the same materials as the fine filter 306, however with a different mesh size (e.g., larger mesh size and/or larger mesh openings). For example, the fine filter 306 can have a mesh size smaller than a mesh size of the coarse filter 304. In at least one example, the coarse filter is made of a spun PLA web similar to the spun PLA web of a fine filter 306, however the coarse filter 514 has a larger space between the filaments in the spun PLA web than the fine filter 306. In some examples, the fine filter 306 and the coarse filter 514 can be made of different materials. For example, the fine filter 306 may be a cellulose paper filter 114 and the coarse filter 514 is a PLA mesh with a mesh size of 1 millimeter. The fine filter 306 can include a filter 114 with a small mesh size, or space between the filter fibers intended to prevent insoluble beverage material 116 from exiting the beverage pod 102 through the brewing pin 126. In at least one example, the fine filter 306 is a spun PLA web. In some examples, the fine filter 306 is a cellulose paper.

FIGS. 3B and 3C illustrate a beverage pod 20 with a deformable filter 114. A deformable filter beverage pod 502B is a beverage pod 20 with a filter 114 which is operable to deform when contacted by the brewing pin 126 of a beverage brewing machine 10.

In at least one example, the deformable filter beverage pod 502B may contain filter reinforcements 312 operable to resist tearing and/or puncturing. The filter reinforcements 312 may be disposed at the bottom of the filter 114. In at least one example, the filter reinforcements 312 may be an altered portion of the filter 114. In some examples, the filter reinforcements 312 can be coupled to the filter 114. In some examples, the filter reinforcements 312 can be disposed between the filter 114 and the bottom of the beverage pod 20.

In at least one example, the filter reinforcements 312 can include a thicker filter material. The filter reinforcements 312 may alternatively be rigid members attached to the filter 114 which cause the filter 114 to tent around the brewing pin 126 to prevent the filter 114 from wrapping around and occluding the brewing pin 126. In at least one example, the filter 114 is comprised of a cellulose paper and the filter reinforcements 312 are comprised of PLA. The filter 114 is a medium for containing beverage material 116 within a beverage pod 102. The filter 114 may be a paper or cloth comprised of fibrous materials such as cellulose. In some examples, the filter 114 may be comprised of a spun PLA web. The filter 114 may be rigid or flexible.

As the filter 114 may be prone to tearing, this may lead to requiring protection from the brewing pin 126 to prevent penetration or tearing or may be durable and resistant to penetration or tearing. In a deformable filter beverage pod 502B, the filter 114 can be flexible with rigid reinforcements 312 and/or the rigid reinforcements 312 can include rigid segments which may bend or otherwise deform, for example, along a hinge where the rigid segments are connected to one another and/or the pod exterior 108. In at least one example, the filter 114 is comprised of at least two layers of cellulose paper. Filter reinforcements 312 can include rigid features attached to a filter 114 which cause the filter 114 to tent or deform in a predictable manner such that the filter 114 is prevented from wrapping around and occluding the brewing pin 126.

In at least one example, the filter reinforcements 312 may include a reinforcing layer attached to the filter 114 with tear resistance to prevent penetration or tearing by the brewing pin 126. In at least one example, the filter reinforcements are comprised of rigid PLA rods which lift the filter 114 away from the brewing pin 126 such that it forms a tent around the brewing pin 126 allowing liquid to flow out of the beverage pod 102 via the brewing pin 126.

As illustrated in FIG. 3C, the deformable filter beverage pod 502B is activated such that the deformable filter beverage pod 502B has been inserted into the brewing chamber 126 of a beverage brewing machine 118 and has been penetrated by a brewing pin 126. The brewing pin 126 has contacted the filter 114 and/or the filter reinforcements 312, and the filter 114 has been deformed around the brewing pin 126. The filter reinforcements 312, upon contacting the brewing pin 126, cause the flexible filter 114 to be tented around the brewing pin 126. In at least one example, the activated deformable filter beverage pod comprises rigid PLA filter reinforcements 312 attached to a dual layer cellulose paper filter 114 which is deformed around a brewing pin 126 creating a space for liquid to flow out the brewing pin 126 while preventing beverage material 116 from exiting the beverage pod 20.

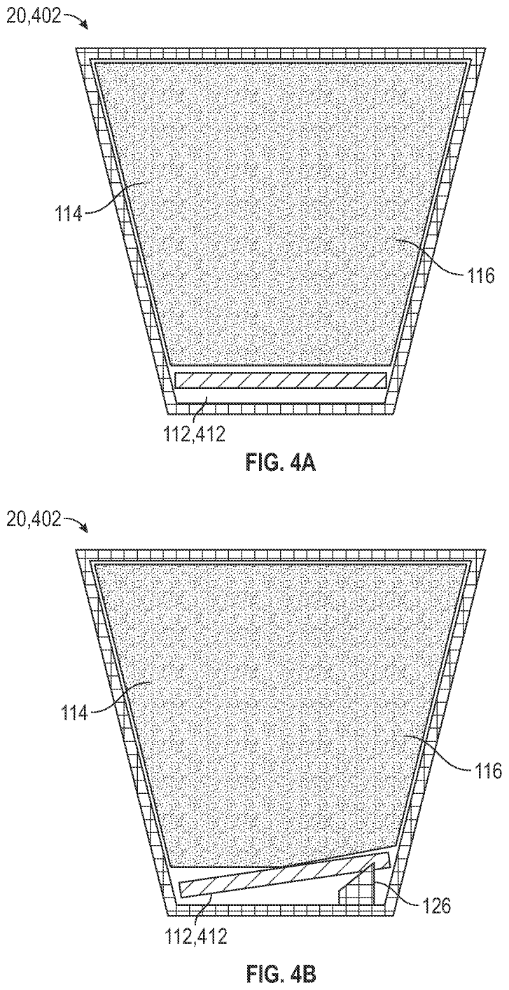

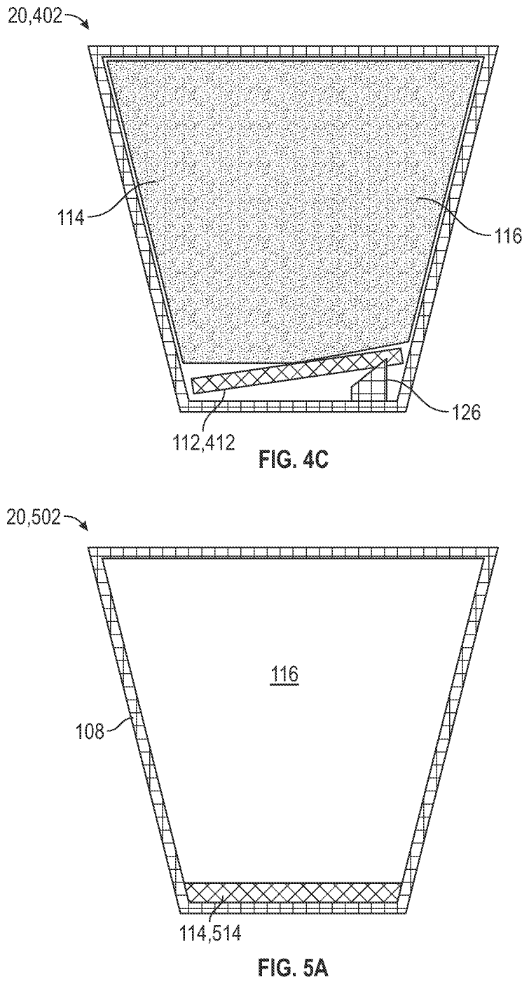

FIGS. 4A-5B illustrate examples of beverage pods 20 in which one or more components such as a registration element 412 and/or a filter 514 changes from an inactive to an active state upon contacting the brewing pin 126. For example, the registration element 412 and/or the filter 514 can change from a dense and/or less porous configuration to a more open and/or more porous configuration so that the beverage can pass through the registration element 412 and/or the filter 514 to the outlet 128.

FIGS. 4A-4C illustrate a beverage pod 402 with an alterable registration element 412. FIG. 4A illustrates an unused beverage pod 402 which is ready for use but has not yet been installed into the brewing chamber 11 of a beverage brewing machine 10. The beverage pod 402 is a sealed container which may be filled with a soluble or insoluble beverage material 116. If the beverage pod 402 contains an insoluble beverage material 116, the beverage pod 402 can additionally include a filter 114. As the filter 114 may be easily damaged, a registration element 112 may be included to protect the filter 114 from damage from the brewing pin 126. The registration element 112 can be operable to contact the brewing pin 126 to prevent direct contact of the brewing pin 126 with the filter 114.

As illustrated in FIGS. 4A-4C, the multistate registration element 412 may have at least two states, an inactive state (shown in FIGS. 4A and 4B) and an active state (shown in FIG. 4C). An unused beverage pod 402 can contain an inactive registration element 412 which may be substantially smaller than an active registration element 412 and similarly may be less porous or additionally capable of providing a water or airtight seal. An unused beverage pod 402 may contain a pod exterior 108 including a pod bottom and/or the pod bottom may be partially or completely omitted with a seal being provided for by an inactive registration element 412. In at least one example, the unused beverage pod 402 can include a pod exterior 108 comprised of PLA, a filter 114 comprised of a spun PLA material, and an inactive registration element 412 which is a compressed cellulose sponge, for example of 1 millimeter in thickness. The filter 114 is a medium for containing beverage material 116 within the beverage pod 402. The filter 114 may be a paper or cloth comprised of fibrous materials such as cellulose. In some examples, the filter 114 may be comprised of a spun PLA web. The filter 114 may be rigid or flexible. The filter 114 may be prone to tearing which results in requiring protection from the brewing pin 126 to prevent penetration or tearing.

In some examples, as illustrated in FIGS. 5A and 5B, a multistate filter 514 may be durable and resistant to penetration or tearing. The filter 514 may, similar to a registration element 412, have an active state (shown in FIG. 5A) and an inactive state (shown in FIG. 5B). Any description of a multistate registration element 412 may similarly apply to the filter 514, as the registration element 412 may be attached to or otherwise integrated into the filter 514.

An inactive registration element 412 is intended to protect the filter 114 of a beverage pod 402, 502 from being damaged by a brewing pin 126. The inactive registration element 412 may change size, shape, or its physical properties. The inactive registration element 412 may additionally contain substances, such as sugar or flavorings, which are intended to be added to a brewed beverage when the inactive registration element 412 is active during the brewing process. In at least one example, the inactive registration element 412 can include a compressed cellulose sponge, for example of 1 millimeter in thickness. In some examples, the inactive registration element 412 includes a disk of compressed or hardened sugar. In some examples, the inactive registration element 412 can contain both soluble and insoluble components such as a mesh or frame of PLA which is at least partially enclosed by a food-safe soluble material such as sugar. The inactive registration element 412 may further create a seal in an unused beverage pod 20 when installed against the bottom of a pod exterior 108 of a beverage pod 20.

An installed beverage pod 402, as illustrated in FIG. 4B, is an unused beverage pod 20 which has been inserted into the brewing chamber 126 of a beverage brewing machine 118 after the brewing chamber lid 122 has been closed causing the brewing pin 126 to penetrate the bottom of the beverage pod 102. The brewing pin 126 contacts the inactive registration element 412 displacing both the inactive registration element 412 and the filter 114 without causing damage to the filter 114. In at least one example, the inactive registration element 412 is not activated in the installed beverage pod 402 until a fluid from the fluid source 120 is injected into the beverage pod 102 via at least one fluid injecting component 124. In at least one example, the installed beverage pod 402 is installed into the brewing chamber 11 of a beverage brewing machine 10 such that the brewing pin 126 penetrates the bottom of the pod exterior 108 and displaces the inactive registration element 412 comprised of a 1 millimeter thick compressed cellulose sponge. The filter 114 and the registration element 412 can remain inactive.

In some examples, as illustrated in FIG. 4C, the registration element 412 may be activated when the installed beverage pod 402 is penetrated by the brewing pin 126. The used beverage pod 402 illustrated in FIG. 4C is an installed beverage pod 402 in which the brewing process, comprised of the injection of fluid, such as water, from a fluid source 120 via at least one fluid injecting component 124 into the installed beverage pod 402 has mixed with the beverage material 116 resulting in a brewed beverage. The fluid may have been heated or cooled to a temperature above or below ambient temperatures or may be at ambient temperatures. The used beverage pod 402 depicts an active registration element 412 such that the inactive registration element 412 has changed to an active state when exposed to either the brewing fluid, a change in temperature or pressure within the beverage pod 402, and/or contact by the brewing pin 126. In at least one example, the used beverage pod 402 can contain an active registration element 412 which was an inactive registration element 412 which, when exposed to the brewing fluid, transitioned to an active registration element 412 by expanding, for example from a thickness of about 1 millimeter thick to a thickness of 4 millimeter thick and becoming increasingly more porous. In some examples, the inactive registration element 412 can include a PLA mesh with a mesh size, for example, of 4 millimeter which can include compressed sugar which transitioned into an active registration element 412 when contacted by a brewing fluid. The brewing fluid can dissolve the compressed sugar leaving behind only the PLA mesh. In some examples, the active registration element 412 can include a mesh such as a PLA mesh with a mesh size of 4 mm which, when the registration element 412 was an inactive registration element 412, held a disk of an additive, such as compressed sugar. The additive can be operable to protect the filter 114 from being contacted and damaged by the brewing pin 126. The additive, such as compressed sugar, can be dissolved by the brewing fluid. In some examples, the additive, such as the compressed sugar disk, or a disk comprised of a different dissolvable or frangible material, may be operable to crack and/or break when being contacted by the brewing pin 126, allowing the fluid to flow through and around the cracked disk.

The primary purpose of an active registration element 412 is to allow the brewed beverage to pass through the registration element 412 so as to exit the beverage pod 102 via the outlet 128. The active registration element 412 may additionally serve to increase the pressure or otherwise provide resistance to the flow of the brewed beverage from the beverage pod 402 to improve the contact time of the brewing fluid with the beverage material 116 improving the strength and quality of the brewed beverage.

FIGS. 5A-5B illustrates beverage pods 20 with multistate filters 514. An unused beverage pod 502, as illustrated in FIG. 5A, is a beverage pod 502 containing an insoluble beverage material 116 and a compressed filter 514 or a filter 114 which is otherwise in an inactive state such that the compressed filter 514 contains a second expanded or active state. The filter 514 is operable to deform by changing into the active state and/or deform and/or displace around the brewing pin 126 such that the brewing pin 126 does not damage the filter 514. The unused beverage pod 502 is a sealed container which may further contain a vacuum, or which may have a neutral gas such as nitrogen, sealed within the unused beverage pod 502 to ensure the freshness of the beverage material 116. In at least one example, the unused beverage pod 502 can be comprised of a PLA pod exterior 108, an insoluble beverage material 116 such as coffee grounds, and a compressed filter 514 such as a compressed cellulose sponge at a thickness of 1 millimeter. In some examples, the compressed filter 514 may be mechanically compressed or collapsed such as a folding PLA structure which becomes porous when contacted by a brewing pin 126.

A compressed filter 514 is a filter 114 which is in a compressed or inactive state. The compressed filter 514 may be comprised of absorbent materials or may be a mix of insoluble materials to form the filter structure and soluble materials which may hold the filter in a compressed state such as sugar. The soluble materials may dissolve when exposed to the brewing fluid allowing the compressed filter 514 to mechanically expand into an expanded filter 514 (shown in FIG. 5B). In some examples, the compressed filter 514 may be held in a state of spring-loaded compression such that when contacted by a mechanical element such as a brewing pin 126 or a solvent, such as a brewing fluid, the force of the spring is released allowing the compressed filter 514 to expand. In at least one example, the compressed filter 514 can include a cellulose sponge material compressed, for example, to a thickness of 1 millimeter. In some examples, a compressed filter 514 can be comprised of a stack of PLA mesh with a spring held in a compressed state by an additive such as a disk of sugar.

A used beverage pod 502, as illustrated in FIG. 5B, is a beverage pod 20 containing an expanded filter 514 or a filter 514 in an active state. The used beverage pod 502 can be penetrated by at least one brewing pin 126 and may have completed the brewing process. The brewing process comprising injecting a brewing fluid from the fluid source 120 into the beverage pod 20, mixing with the brewing chamber 115 to brew a beverage, and expanding a compressed filter 514 allowing the brewed beverage to exit the beverage pod 102 via at least one outlet 128. In at least one example, the used beverage pod 502 can include a PLA pod exterior 108, an insoluble beverage material 116, and an expanded filter 514 wherein the pod lid 104 has been penetrated by at least one fluid injecting component 124. The bottom of the pod exterior 108 can be penetrated by at least one brewing pin 126, and the expanded filter 514, previously being in the inactive state of a compressed filter 514, has been caused to transition into an active state as an expanded filter 514. The filter 514 may expend by absorbing a portion of the brewing fluid, such as water, and/or dissolving a soluble mechanical component, such as a disk of sugar allowing the filter 114 to expand or otherwise transition into an active state. An expanded filter 514 is the active state of a compressed filter 514. The expanded filter 514 may have expanded due to a chemical interaction, such as the dissolution of a soluble element such as one made of sugar, and/or due to a mechanical interaction such as a component fracturing in response to being contacted by a brewing pin 126 and expanding in response to the release of a spring force. The expanded filter 514 may alternatively result from an increase in temperature or pressure which may cause a compressed filter 514 to inflate or delaminate, allowing the beverage material to flow through the expanded filter 514. In at least one example, the expanded filter is a cellulose sponge which as a compressed filter 514 can have a thickness for example 1 millimeter thick and minimally porous, and as an expanded filter 514, the cellulose sponge may have expanded to a thickness for example of 4 millimeters after being exposed to an absorbing a portion of brewing fluid such as water.

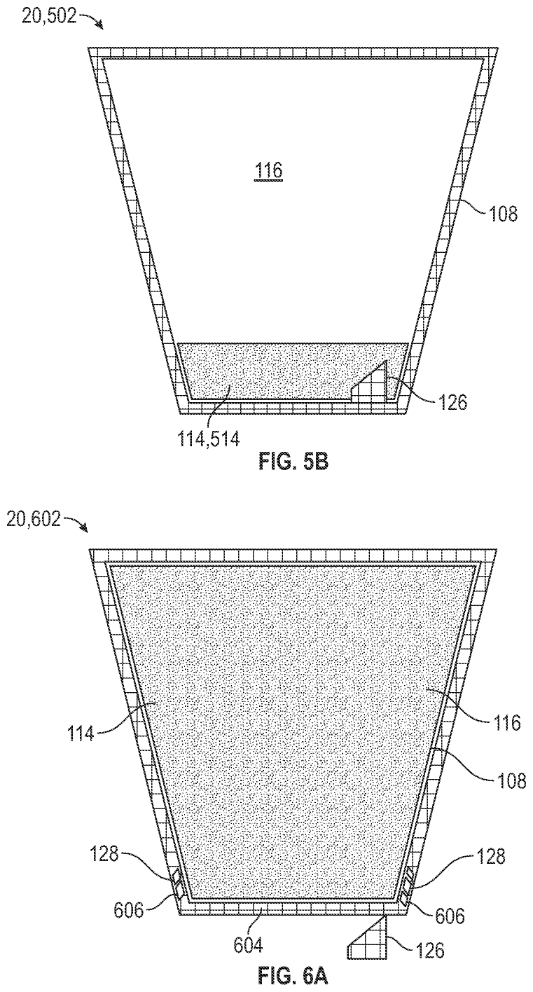

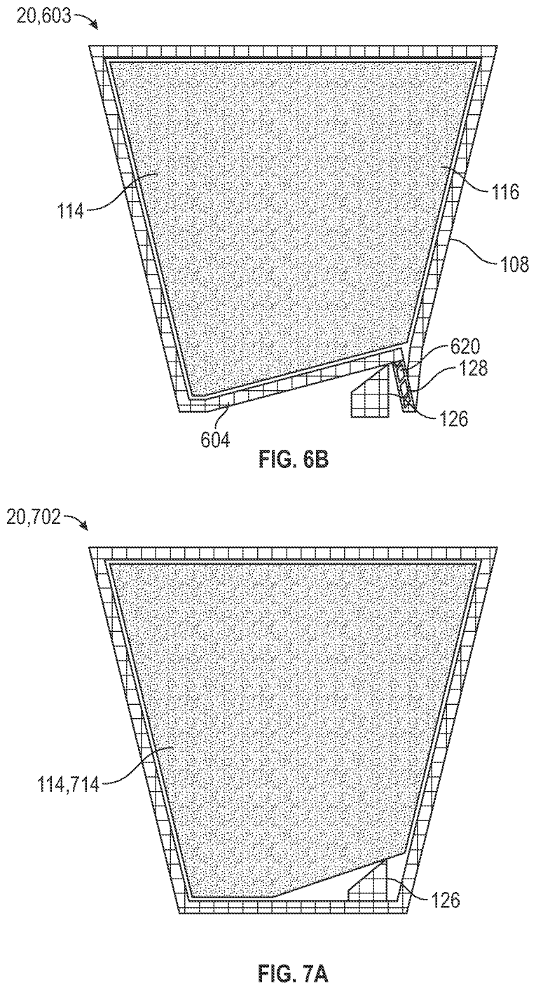

FIG. 6A illustrates a beverage pod 602 with one or more porous sides 606. A porous side beverage pod 602 is a beverage pod 20 in which one or more sides of the beverage pod 602 provides for an outlet 128 to allow a brewed beverage to exit the beverage pod 602. The beverage pod's 602 sides may comprise two states, a sealable non-porous state and a second porous state where a brewed beverage can exit the beverage pod 602. In at least one example, the beverage pod 602 includes a pod exterior 108 with one or more sides which includes openings 606 adjacent the bottom 604 of the pod exterior 108. The openings 606 can initially be sealed, for example with a dissolvable film, creating a sealed beverage pod 602 which is operable to dissolve when contacted by the brewing fluid, transitioning into an outlet 128 for the brewed beverage. The porous side beverage pod 602 may not require the penetration of the pod bottom 604 by the brewing pin 126 to release the beverage. With the porous side openings 606, the filter 114 may not come in contact with the brewing pin 126 which can prevent damage to the filter 114. The porous side openings 606 can be a part of a pod exterior 108 which may transition from a first, nonporous, sealable state to a second, porous state such that when the porous side openings 606 are in the first state, the beverage pod 102 is a sealed container, protecting the contents from the outside environment. When in the second state, the porous side openings 606 can form an outlet 128 allowing a brewed beverage to exit the beverage pod 602.

In at least one example, the porous side openings 606 may be formed by a static opening in the pod exterior 108 which does not change shape. The porous side openings 606 may be sealed by a dissolvable film or material including sugar or polyvinyl alcohol (PVA). In some examples, the porous side openings 606 may be a dynamic opening where the pod exterior 108 is comprised of multiple sections which may slide against one another when the bottom 604 of the beverage pod 602 is contacted by the brewing pin 126. The sliding of the two sections may align openings 606 in each of the sections creating at least one outlet 128 though which a brewed beverage can exit the beverage pod 602. In at least one example, the porous side 606 can include a series of small openings 606, for example each at least 1 millimeter by 3 millimeters, in the side of the beverage pod 602, located a distance, for example between 2 millimeters and 4 millimeters from the bottom 604 of the beverage pod 102. The openings 606 may be covered, for example by a PVA film, by a seal which dissolves when contacted by the water brewing fluid. The pod bottom 604 is the downward facing surface of the pod exterior 108 which is designed to be contacted by the brewing pin 126 of a beverage brewing machine 10.

In a porous side beverage pod 602 (shown in FIG. 6A) or a shearing side beverage pod 603 (shown in FIG. 6B), the pod bottom 604 is reinforced, or otherwise designed to be resistant to penetration or damage by a brewing pin 126. The pod bottom 604 may contain reinforcing material, such as a mesh embedded into the pod bottom 604 or may alternatively be comprised of a thickened pod exterior 108 material. In at least one example, the pod bottom 604 can include PLA with a thickness, for example of 2 millimeters whereas the remaining pod exterior 108 can be comprised of a thinner thickness, for example 1 millimeter thick PLA.

FIG. 6B illustrates a beverage pod 603 with a shearing region 620. A shearing side beverage pod 603 is a beverage pod 20 with a pod exterior 108 that includes a weakened region 620 near the bottom 604 of the side of the beverage pod 603. The shearing side beverage pod 603 can be similar to a porous side beverage pod 602, however the shearing side beverage pod 603 is operable to create a porous outlet 128 through the mechanical failure or shearing of the shearing region 620 of the beverage pod 603. The shearing side beverage pod 603 may have a region of weakened pod exterior 108 material where the shearing region 620 is desired such that when the pod bottom 604 is contacted by the brewing pin 126, the side of the pod exterior 108 shears or otherwise fails at the region 620 of weakened material creating an outlet 128. In at least one example, the shearing side beverage pod 212 is comprised of a pod exterior 108 with a weakened region 620, for example made of PLA, which has a first thickness, for example 0.5 millimeters thick, around the circumference of the beverage pod 603, and a second thickness which is greater than the first thickness, for example 2 millimeters, from where the side meets the pod bottom 604, whereas the remaining side of the pod exterior 108 can have a third thickness, for example 1 millimeter thick, which is between the first thickness and the second thickness so that when the pod bottom 604 is contacted by the brewing pin 126, the weakened region fails creating an outlet 128 through which a brewed beverage can exit the beverage pod 102.

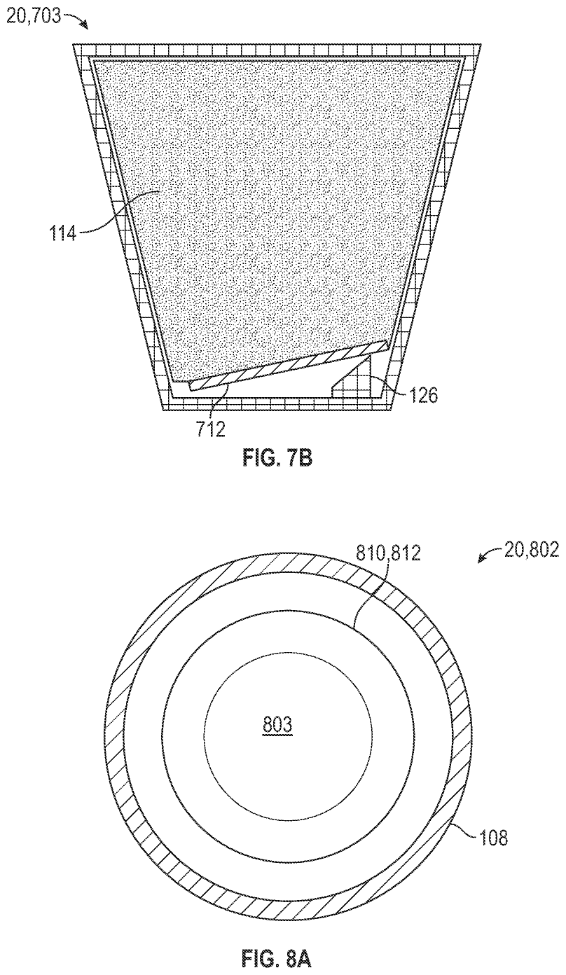

FIGS. 7A and 7B illustrate beverage pods 702, 703 having puncture resistant components (e.g., puncture resistant filter 714 and/or puncture resistant filter reinforcement 712).

FIG. 7A illustrates a beverage pod 702 with a puncture resistant filter 714. A puncture resistant filter beverage pod 702 is a beverage pod 20 that includes a puncture resistant filter 714. The puncture resistant filter 714 can include materials or features which resist puncture by a brewing pin 126. The puncture resistant filter 714 can be deformed and/or displaced around the brewing pin 126 without failing. In at least one example, similar to FIG. 3A, the puncture resistant filter 714 can be comprised by two layers, for example of cellulose paper, and in some examples a third layer for example including PLA mesh sandwiched between the first and second layers of cellulose paper to create a puncture resistant filter 714. In at least one example, the puncture resistant filter 714 can be held in place via a pod bond 106. In at least one example, the puncture resistant filter 714 may utilize multiple layers of material, such that one material may be used as a filter 114, to prevent the beverage material 116 from exiting the beverage pod 702 while a second layer may be used to provide the puncture resistant properties. In some examples, the puncture resistant filter 714 may be comprised of a single layer of material which is inherently puncture resistant, such as a flexible silicone material, which may deform and stretch but is otherwise not easily penetrated, or an interwoven cloth comprised of threads which are not easily cut or frayed. In at least one example, a puncture resistant filter 714 can include a woven cloth comprised of cellulose fibers which resists tearing when contacted by the brewing pin 126.

FIG. 7B illustrates a beverage pod 703 with a reinforced filter 114. A reinforced filter beverage pod 703 can include a filter 114 which has a filter reinforcement 712 where the filter 114 may be contacted by a brewing pin 126. In at least one example, the filter reinforcement 712 can be disposed between the filter 114 and the bottom of the beverage pod 703. In some examples, the filter reinforcement 712 can be coupled to the filter 114. The filter reinforcement 712 may include a rigid disk and/or registration element 712. In at least one example, the filter reinforcement 712 may have a hollow portion for capturing the brewing pin 126 without allowing it to fully penetrate the filter reinforcement 712 (for example the registration element of FIG. 2A). The hollow portion may additionally comprise a filter 114 medium (for example the registration elements of FIGS. 2B-2C). The filter reinforcement 712 may alternatively be comprised of flexible materials.

The filter reinforcement 712 may be flat or may follow the shape of the filter 114. In at least one example, the reinforced filter beverage pod 308 comprises a filter 114 of cellulose paper to which is affixed a filter reinforcement 712 comprised of a disk of PLA 1 millimeter thick. A filter reinforcement 312 is a feature similar to a registration element 712 which is affixed to a filter 114 by an adhesive of mechanical means. The filter reinforcement 712 may be rigid, flexible or contain a combination of rigid and flexible components. The filter reinforcement 712 may be a simple flat shape, such as a disk, or may include complex features such as convex or concave curves or facets. The filter reinforcement may be solid, hollow, or may comprise an internal structure with several hollow spaces or may contain a loose material such as a filter medium.

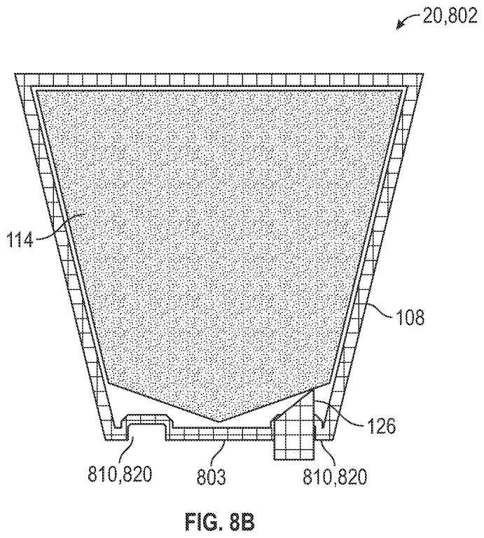

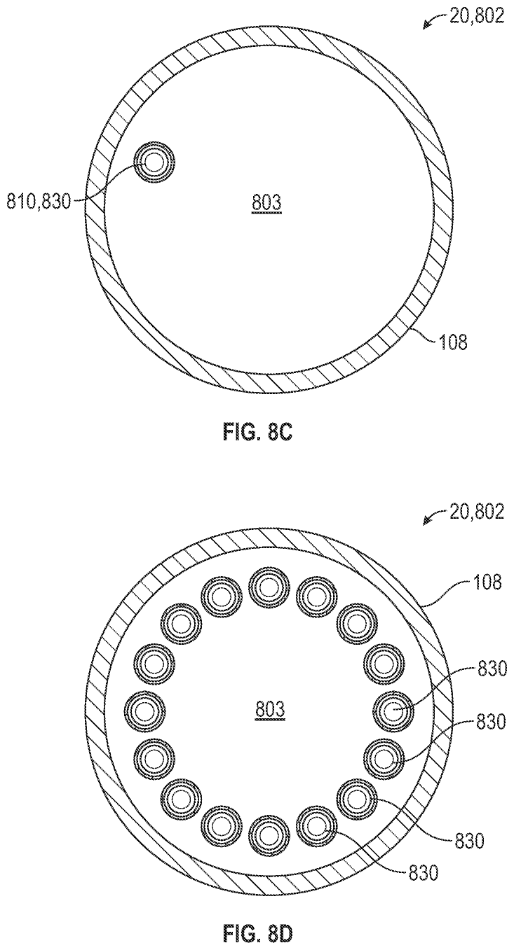

FIGS. 8A-8D illustrate examples of beverage pods 20 having pin alignment portions 810. The pin alignment portions 801 can be operable to receive and/or align the brewing pin 126 so that the brewing pin 126 pierces and/or contacts the bottom 803 of the beverage pod 802 at the desired position.

FIG. 8A illustrates a beverage pod 802 with a depressed ring 812 functioning as the pin alignment portion 810. The bottom 803 of the pod exterior 108 includes a depressed ring 812. In at least one example, the depressed ring 812 can be in the form of a ring-shaped depression and/or recess in the bottom 812 of the beverage pod 802. The depressed ring 812 is operable to provide a channel into which the brewing pin 126 can be received, ensuring that the brewing pin 126 will be aligned to penetrate the beverage pod 802 only along the depressed ring 812.

In at least one example, the depressed ring 812 may be thinner than the surrounding pod exterior 108. In at least one embodiment, the depressed ring 812 can be centered on the bottom 803 of the pod exterior 108 such that the depressed ring 812 is a predetermined distance, for example 2 millimeters, from the edge of the bottom 803 of the beverage pod 802. In at least one example, the depressed ring 812 can have a width, for example about 3 millimeters, and a depth at its deepest point of recess into the beverage pod 802, for example at least 3 millimeters. The brewing pin 126 of a beverage brewing machine 118 aligns into the depressed ring 812 of the beverage pod 802 such that the brewing pin 126 contacts the deepest point of the depressed ring 812. A depressed ring 812 can include a circular region on the bottom 803 of the beverage pod 802 which is indented into the beverage pod 802. In at least one example, the depressed ring 812 can create a channel which aligns with the brewing pin 126 such that the brewing pin 126 will penetrate the beverage pod 102 at the deepest point of the depressed ring 812. In some examples, the deepest point of the depressed ring 812 may be thinner than the surrounding pod exterior 108 and/or the rest of the depressed ring 812 so as to facilitate easier penetration of the brewing pin 126. The alignment depression 820 can be concave with the deepest point aligning to where a brewing pin 126 would contact the beverage pod. In some examples, the depressed ring 812 can taper from the thickness of the surrounding pod exterior 108, for example about 1 millimeter, to a thickness, for example about 0.5 millimeters, at the deepest point of the depressed ring 812.

In at least one example, as illustrated in FIG. 8B, the beverage pod 802 can include an alignment depression 820 as the pin alignment portion 810. The alignment depression 820 can be recessed into the bottom 803 of the beverage pod 802. The alignment depression 820 can be operable to align the beverage pod 802 in the desired position in the brewing chamber 11. The alignment depression 820 can include an indentation in a part of the pod exterior 108 of a beverage pod 802 which engages with a protruding feature of a brewing chamber 126. The protruding feature of the brewing chamber 11 may be a functional element of the brewing chamber 11 such as the brewing pin 126. In some examples, the protruding feature may include a protrusion of rigid material into the brewing chamber 11 for aligning the beverage pod 102 such that the protrusion nests within the alignment depression 820. The alignment depression 820 may be on the bottom 803 and/or on the side of a pod exterior 108. The alignment depression 820 allows for only a single orientation in which the beverage pod 802 can be aligned. In some examples, multiple alignment features may be utilized, usually in a symmetrical or repeating pattern so as to allow multiple valid alignments. The alignment depression 820 may additionally comprise an area of thinner pod exterior 108 material than the rest of the pod exterior 108 and/or may alternatively be replaced by a pod lid 104 which may be more easily punctured by a brewing pin 126.

In at least one example, the alignment depression 820 can include an indentation of the bottom 803 of the beverage pod 802 in a continuous ring shape at a consistent distance from the center of the beverage pod 802 so that the brewing pin 126 would align with the alignment depression 820 regardless of the orientation of the beverage pod 802. In some examples, the alignment depression 820 can include a region on the bottom 803 of the pod exterior 108 of a beverage pod 802 which is recessed into the beverage pod 802 such that the brewing pin 126 can align with the alignment depression 820. In some examples, the recessed alignment depression 820 can be 0.5 millimeters thick while the surrounding pod exterior 108 is at least 1 millimeter thick.

FIG. 8C illustrates a dimpled alignment depression 830 on the bottom 803 of the beverage pod 802. At least one dimpled alignment depression 830 can be provided on the bottom of the pod exterior 108. The dimpled alignment depression 830 may alternatively be located on the side of the beverage pod 802. The dimpled pod bottom 803 is operable to align the brewing pin 126 of a beverage brewing machine 10 with a dimpled alignment depression 830 such that the brewing pin 126 contacts the deepest part of the dimpled alignment depression 830. The dimpled alignment depressions 830 create valid alignment orientations such that the outlet 128 or brewing pins 126 can penetrate the beverage pod 802 without damaging the filter 114 and/or ensuring intended performance of the beverage pod 802.

As illustrated in FIG. 8D, the dimpled pod bottom 803 may contain a plurality of dimpled alignment depressions 830 to provide multiple valid alignments and/or to accommodate multiple brewing pins 126. In at least one example, the dimpled pod bottom 803 can contain one dimpled alignment depression 830 in the shape of a conical depression having diameter, for example 4 millimeters, and extending a distance, for example 3 millimeters, into the beverage pod 802. The dimpled alignment depression 830 may be round in shape or may be in the shape of a polygon. The dimpled alignment depression 830 may alternatively be in the shape of a channel such as a vertical channel extending at least part of the height of the beverage pod 802 creating an indentation into the side of a pod exterior 108. A dimpled alignment depression 830 includes a depression which is at least 1 millimeter in depth, recessed into the side or bottom 803 of the beverage pod 802. In at least one example, the dimpled alignment depression 830 can be in the shape of a concave semicircle. In some examples, the dimpled alignment depression 830 can have a conical shape. In some examples, the dimpled alignment depression 830 can have vertical sides at a 90° angle to both the bottom of the beverage pod 802 and the deepest surface of the dimpled alignment depression 830.

The features discussed above in relation to FIGS. 1A-8D can be interchanged and/or combined within beverage pods 20 without deviating from the scope of the disclosure so long as the filter, the registration element, and/or the beverage pod is operable to deform and/or displace such that the beverage passes through an outlet while preventing damage to the filter by the brewing pin.

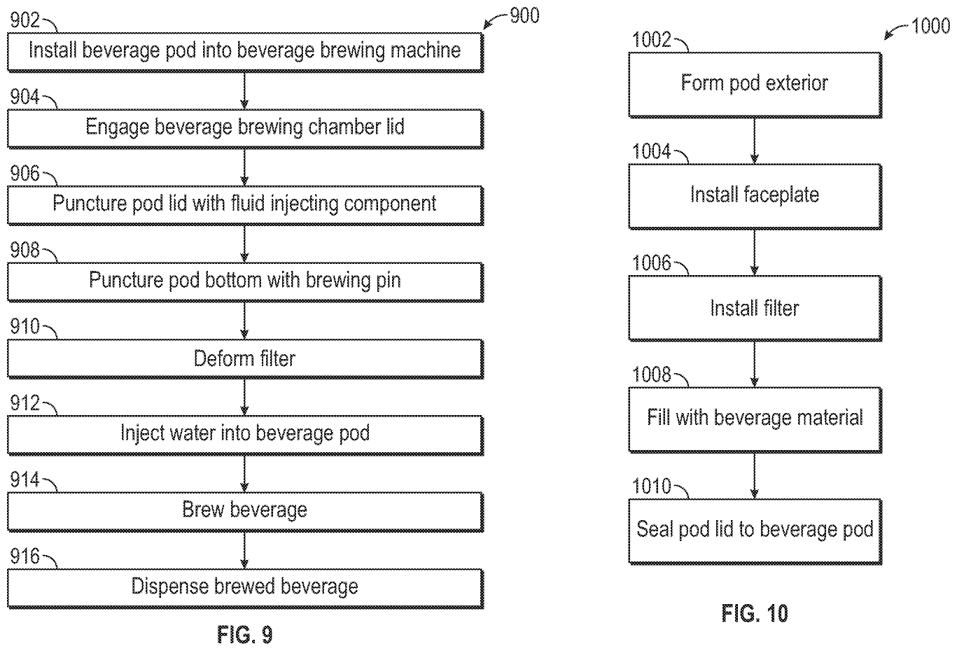

Referring to FIG. 9, a flowchart directed to an installation process is presented in accordance with an example embodiment. The method 900 is provided by way of example, as there are a variety of ways to carry out the method. The method 900 described below can be carried out using the configurations illustrated in FIG. 1A-8D, for example, and various elements of these figures are referenced in explaining example method 900. Each block shown in FIG. 9 represents one or more processes, methods or subroutines, carried out in the example method 900. Furthermore, the illustrated order of blocks is illustrative only and the order of the blocks can change according to the present disclosure. Additional blocks may be added or fewer blocks may be utilized, without departing from this disclosure.

The process begins with installing, at block 902, a beverage pod into a beverage brewing machine. The beverage pod can contain a soluble or insoluble beverage material or a mixture of soluble and insoluble beverage materials. The beverage pod can be positioned such that the pod lid is facing upward. In at least one example, the beverage pod contains coffee grounds.

At block 904, the brewing chamber cover is engaged such that the beverage pod is fully enclosed within the brewing chamber. In an example, engaging the brewing chamber cover by pulling down on a lever, latching the brewing chamber cover such that the brewing chamber is a sealed.

At block 906, the pod lid can be punctured with the fluid injecting component. The fluid injecting component can be operable to provide an inlet for a fluid from a fluid source to be injected into the beverage pod. In at least one example, the fluid injecting component is a metal tube which has been cut off at an angle and sharpened to form a point and penetrates the pod lid when the brewing chamber cover is engaged. In some examples, the pod lid is penetrated by more than one fluid injecting component.

At block 908, the bottom of the pod exterior can be punctured with the brewing pin. The brewing pin is operable to provide an outlet for the brewed beverage to exit the beverage pod. In at least one example, the brewing pin is a metal tube which has been cut off at an angle and sharpened to form a point and penetrates the bottom of the pod exterior when the brewing chamber lid is engaged. In some examples, the bottom of the pod exterior is penetrated by more than one brewing pin.

At block 910, the filter within the beverage pod is displaced when contacted by the brewing pin. The brewing pin may alternatively contact a registration element which may be penetrated by and contain the brewing pin, preventing the brewing pin from contacting the filter. In at least one example, the filter is a reinforced filter comprising a cellulose paper layer and a second PLA mesh layer for preventing the brewing pin from tearing the cellulose paper layer.

At block 912 liquid, usually water, can be injected into a beverage pod. In some examples, another liquid may be used such as milk or a juice. In at least one example, water is injected into the beverage pod via the fluid injecting component.

At block 914, a beverage is brewed by mixing the liquid injected into the beverage pod with the beverage material. The beverage material may be soluble or insoluble. The beverage may be brewed using a cold liquid or a liquid heated to a desired temperature which may or may not be adjustable. In at least one example, the beverage material is comprised of insoluble coffee grounds and is brewed by the injection and mixing of water heated to at least 90° C. with the beverage material. In some examples, the beverage material is comprised of a soluble hot cocoa mix which dissolves into heated water. In some examples, the beverage material is comprised of insoluble tea leaves which is cold brewed with water at room temperature or which has been chilled to a temperature below the ambient room temperature.

At block 916, the brewed beverage is dispensed from the beverage pod via the outlet. The outlet may be a feature of the brewing pin, may be an opening at the base of the brewing pin and/or formed in the beverage pod. In at least one example, the brewed beverage is coffee which exits the beverage pod via at least one orifice in a brewing pin.

Referring to FIG. 10, a flowchart directed to the manufacturing process is presented in accordance with an example embodiment. The method 1000 is provided by way of example, as there are a variety of ways to carry out the method. The method 1000 described below can be carried out using the configurations illustrated in FIG. 1A-8D, for example, and various elements of these figures are referenced in explaining example method 1000. Each block shown in FIG. 10 represents one or more processes, methods or subroutines, carried out in the example method 1000. Furthermore, the illustrated order of blocks is illustrative only and the order of the blocks can change according to the present disclosure. Additional blocks may be added or fewer blocks may be utilized, without departing from this disclosure.

At block 1002, the pod exterior of a beverage pod is formed using an injection molding machine. A thermoplastic is heated to a temperature greater than the melting point of the plastic which is then injected into the mold where the pod exterior is formed in the mold and cooled before being ejected from the mold. In some examples, the pod exterior may be formed by alternative methods of forming thermoplastics such as thermoforming, blow molding, etc. The pod exterior may be further annealed. An optional second layer may be fused to the pod exterior to reinforce the pod exterior. The registration element and/or filter may be formed simultaneously with the pod exterior or independently as discrete components. In an example, the pod exterior is formed via injection molding using PLA.

At block 1004, a registration element can be installed into the bottom of the pod exterior. The registration element may be loose fitting or secured by a pressure fit or alternatively using adhesives or a plastic weld. The registration element may be a solid disk or may be hollow. The registration element may contain an internal structure or may be a loose material in the bottom of the beverage pod. In at least one example, the registration element is a disk of PLA. In some examples, the registration element is a hollow registration element comprised of thin layers of PLA around an enclosed space. The hollow registration element may alternatively contain an internal support structure such as a repeating hexagonal prism. In a further example, the registration element may be a loose material such as PLA spheres.

At block 1006, a filter is installed into the pod exterior, on top of an installed registration element if a registration element is needed. The filter may fill the bottom of the beverage pod or may extend up the sides of the beverage pod. The filter may be secured via a pod bond or may be free floating within the pod exterior. The filter may be thin and prone to damage or may be reinforced and resistant to damage or failure. The filter may additionally include flexible or rigid supports for controlling the deformation of the filter when contacted by a brewing pin. In example, the filter is comprised of a cellulose paper bonded to the rim at the top of the pod exterior 108 via a pod bond. In an alternate example, the filter is comprised of a spun PLA web. In a further example, the filter is comprised of a first cellulose paper layer and a second PLA mesh layer with rigid PLA supports along the mesh layer such that the PLA mesh layer protects the cellulose paper layer from damage and the rigid PLA supports cause the filter to deform around the brewing pin in a manner so as to create a void space around the outlet to prevent the outlet from becoming occluded.

At block 1008, a beverage pod is filled with beverage material. The beverage material may be soluble, insoluble, or a mixture of soluble and insoluble beverage material. In at least one example, 10 grams of coffee grounds are inserted into the beverage pod.

At block 1010, a pod lid can be sealed to the top rim of a beverage pod via a pod bond. The pod bond may be any of a chemical adhesive, a mechanical bond, such as welding the pod lid to the plastic of the pod exterior, or by crimping the rim of the pod exterior around the edges of the pod lid. The pod bond forming a seal between the pod lid and the pod exterior. Prior to or during the sealing of the beverage pod, a vacuum may be created within the beverage pod or a gas, such as nitrogen, may be injected into the beverage pod to replace the air in the beverage pod to improve the shelf life of the beverage material. In at least one example, a pod lid is ultrasonically welded to the top rim of the pod exterior creating a sealed beverage pod.

The examples shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described above may be modified within the scope of the appended claims.

What is claimed is:

1. A beverage pod comprising:
an outer shell having a bottom layer, a lid opposite the bottom layer, and side walls between the bottom layer and the lid, wherein the bottom layer is operable to be breached by a brewing pin from a beverage brewing machine;
a filter forming a chamber operable to contain a beverage material, the beverage material operable to mix with a liquid to form a beverage;
wherein the filter is operable to resist tearing and/or occlusion such that the beverage passes through an outlet while preventing damage to the filter by the brewing pin.

2. The beverage pod of claim 1, wherein the filter includes a layered filter operable to resist damage from contacting the brewing pin.

3. The beverage pod of claim 2, wherein the layered filter includes a fine filter operable to contain beverage material and a coarse filter operable to protect the fine filter from damage from the brewing pin.

4. The beverage pod of claim 3, wherein the fine filter has a mesh size smaller than a mesh size of the coarse filter.

5. The beverage pod of claim 3, wherein the fine filter and the coarse filter are made of different materials.

6. The beverage pod of claim 1, wherein the filter includes filter reinforcement operable to resist tearing and/or puncturing by the brewing pin.

7. The beverage pod of claim 6, wherein the filter reinforcement, upon contacting the brewing pin, causes the filter to be tented around the brewing pin.

8. The beverage pod of claim 1, further comprising a registration element operable to contact the brewing pin to prevent direct contact of the brewing pin with the filter.

9. The beverage pod of claim 8, wherein the registration element has at least an inactive state and an active state.

10. The beverage pod of claim 9, wherein the registration element in the inactive state is less porous than in the active state.

11. The beverage pod of claim 9, wherein the registration element is operable to transition into the active state when exposed to the liquid injected into the beverage pod via a fluid injecting component of a beverage brewing machine, a change in temperature and/or pressure within the beverage pod, and/or contact by the brewing pin.

12. The beverage pod of claim 9, wherein the registration element includes an additive operable to protect the filter from being contacted and damaged by the brewing pin.

13. The beverage pod of claim 12, wherein the additive is operable to be dissolved by the liquid to transition the registration element to the active state and/or the additive is operable to crack and/or break when being contacted by the brewing pin, allowing the beverage to flow through and around the additive.

14. The beverage pod of claim 8, wherein the registration element is operable to increase the pressure and/or provide resistance to flow of the beverage to improve contact time of the liquid with the beverage material.

15. The beverage pod of claim 1, wherein the filter has at least an inactive state and an active state.

16. The beverage pod of claim 15, wherein the filter is operable to deform by changing into the active state and/or deform and/or displace around the brewing pin such that the brewing pin does not damage the filter.

17. The beverage pod of claim 15, wherein the filter is operable to transition to the active state by expanding due to a chemical interaction, a mechanical interaction by being contacted by the brewing pin, increase in temperature, and/or increase in pressure.

18. The beverage pod of claim 1, further comprising openings that are initially sealed which are operable to dissolve when contacted by the liquid to transition into an outlet for the beverage.

19. The beverage pod of claim 1, wherein the side walls include a shearing region, wherein when the bottom layer is contacted by the brewing pin, the side walls shear and/or fails at the shearing region to create an outlet for the beverage.

20. The beverage pod of claim 1, wherein the bottom layer includes one or more pin alignment portions operable to receive and/or align the brewing pin so that the brewing pin pierces and/or contacts the bottom layer of the beverage pod at a desired position.
